(19) United States
(12) Patent Application Publication
(10) Pub. No.: US 2026/0314580 A1
(43) Pub. Date: Oct. 15, 2026

(54) FISHING DEVICE FOR A RUBBER BAIT

(71) Applicant: Markus von Euw, Steinen (CH)

(72) Inventor: Markus von Euw, Steinen (CH)

(21) Appl. No.: 19/101,383

(22) PCT Filed: Jul. 26, 2023
(86) PCT No.: PCT/EP2023/070682

§ 371 Date: Feb. 5, 2025

(30) Foreign Application Priority Data
Aug. 5, 2022 (DE) 10 2022 119 749.2

(51) Int. Cl. A01K 85/00; A01K 83/06; A01K 85/18

(52) U.S. Cl. CPC A01K 85/1833; A01K 83/06; A01K 85/18; A01K 85/1803; A01K 85/1867

(57) ABSTRACT

A fishing device for a rubber jig for fishing includes a jig head with a through-hole that extends from a head upper face to a head lower face and that receives a clip and includes a first blind hole that leads from the rear of the head into the head and is used to receive a jig mounting such that the through-hole wall lying opposite the blind hole is formed therein and which guides the jig mounting forms a stop for the jig mounting, the jig mounting secured to the jig head, having a front end, a central section, and a rear end, the front end of the jig mounting curved to form a through-opening, the clip plugged into the through-hole and through the through-opening of the jig mounting and releasably connected to the jig head and the jig mounting to secure the jig mounting.

### BACKGROUND OF THE INVENTION

The invention relates to a fishing device for a rubber bait for catching fish according to the preamble of claim 1 and to an arrangement thereof and to a method for producing the fishing device according to claims 20 and 21.

Various fishing baits and fishing bait devices are known in the art. For example, EP 3 104 698 B1 discloses a fishing bait for imitating the swimming of a fish, which comprises a rigid head, consisting of a flat rear portion and a fastening means for a fishing line. It also comprises a fishing hook and a flexible body which extends between a front end and a rear end. A somewhat more complex fishing device is disclosed in EP 2 918 167 B1, this being a spinning bait fishing device. A disadvantage of the prior art is that many different individual components have to be screwed or plugged together or otherwise fastened to one another before fishing is possible. In addition, a soft plastics material fishing bait, if used, has to be placed on a barb, and this regularly leads to injuries in the hand region and causes massive wear to the bait body every time the weight is changed, since it has to be pierced again each time.

Therefore, an object of the present invention is to provide a fishing bait device, which can be used for fishing, as quickly as possible and with little manual work or few steps.

### SUMMARY OF THE INVENTION

According to the invention, a fishing device for a rubber bait for catching fish is provided, which comprises a bait head, a bait holder and a clasp. Therefore, only three system components are initially required so as to provide a fishing bait device for a rubber bait. The fishing device or bait system is in particular characterised in that a bait holder for releasable attachment to the bait head is provided. This bait holder has at least a front end, a middle portion and a rear end. The middle portion and rear end (also jointly referred to as the middle portion with a head-side portion region) are expediently rod-shaped or straight. At its front end, which is curved, preferably forming an elongate eyelet, and thus forms a through-opening, the bait holder is inserted into a first blind hole in the bait head, the blind hole leading, preferably horizontally, from the rear head, particularly preferably from the middle region of the rear head, into the head. The bait holder is then secured with the clasp, which is preferably pushed from below into a through-hole provided in the bait head. The through-hole preferably extends vertically from the head upper face to the head lower face and serves to hold the clasp. The through-hole may alternatively lead diagonally through the head, in which case the angle to the longitudinal axis of the bait holder is between greater than 0 ° and less than 180 °, preferably between 1 ° and 179 °, particularly preferably between 50 ° and 130 °, in particular between 50 ° and 90 °. The wall of the through-hole opposite the first blind hole or an end of a continuing second blind hole formed in this wall expediently forms a stop for the front end of the bait holder. The three system elements comprising the bait head, bait holder and clasp can be interconnected quickly and easily and can be removed from their arrangement again. To form the through-opening at the front end of the bait holder, the front end of the bait holder is bent back and preferably formed as an elongate eyelet which extends in the longitudinal direction of the axis A of the bait holder and can be releasably inserted into the blind hole. The clasp, which can be inserted into the through-hole in the head and through the through-opening of the bait holder which is already inserted into the head, is thus releasably connected to the bait head and bait holder to secure the bait holder in the bait head.

A rubber bait may be attached to the middle portion and/or to the rear end of the bait holder. The fishing device is then ready for use, a fishing line, hook, carabiner or the like expediently being attached to an upper end of the clasp, in particular in a receptacle which is formed by the upper end and which preferably protrudes upwards from the head upper face or from the through-hole, and potentially a fishing hook, for example a treble hook, being attached to the lower end of the clasp, in particular in a receptacle which is formed by the lower end and which expediently protrudes downwards from the head lower face or from the through-hole. Alternatively, the fishing hook may be attached to the rubber bait or to the upper end. Preferably, the upper end (or lower end) of the clasp, which protrudes from the through-hole, is formed as an eyelet, which is tapered by comparison with the lower end (or upper end) of the clasp (vice versa). Instead of attaching a fishing line, it is advantageous to attach a hook or carabiner to the upper end (top) of the clasp. This ensures, as a result of its strength and thickness, that the clasp cannot slip out. With a thin fishing line tied to the top of the clasp, the clasp could be pulled back down or could slide down out of the through-hole on its own.

Furthermore, the fishing hook according to the present invention can be attached to the clasp in three different ways. In a first possible embodiment, the fishing hook or the fishing hook system is hooked directly into the clasp. The fishing hook or the fishing hook system is preferably attached before the clasp is inserted into the through-hole with the upper end first. The hook is thus securely secured in the lower end of the clasp. In a second, alternative embodiment, a snap ring is pushed or pulled over the upper end of the clasp from above. This is then secured by threading the hook or carabiner into the upper end, preferably the tapered eyelet, and thus attached to the head at the top. In this case, the hook or the hook system is also attached to the upper end of the clasp. As a third possible embodiment, the snap ring of the hook system can be attached through the upper end of the clasp after the bait holder and clasp are in their mounted position. In this case, the three elements, namely the clasp, bait holder and head, are secured in the same way as the hook or carabiner which prevents the clasp from loosening and slipping out of the through-hole.

It is also advantageous that the plug-in system elements, in other words the bait head, clasp and bait holder, do not release from one another without the application of force once assembled. Once plugged together, they therefore form a stable and reliable fishing device which can easily withstand flow resistance or similar external influences.

To further stabilise the connection between the clasp and the bait holder in the through-hole, the clasp is formed like a staple. As a result, it is clamped in the through-hole and cannot come loose from its mounted position in the event of impacts or other external influences on the fishing device. Expediently, two legs of the clasp are arranged overlapping one another, the inner leg being pretensioned in such a way that it presses outwards on the leg resting thereon and presses it against the wall surface of the through-hole facing the rear head. This creates a clamping effect which fixes the clasp even better in the through-hole.

The upper and/or lower end of the clasp, which protrudes from the head or the through-hole as described above, therefore has a receptacle for attaching additional elements, such as fishing line, hooks or carabiners, fishing hooks or fishing hook systems. This receptacle is expediently annular, angular or eyelet-shaped. In particular, the receptacle is wider, either at the upper or at the lower end of the clasp, than the diameter of the through-hole. At the opposite end of this wider formation and the region leading through the through-hole, the clasp is as wide as the through-hole. The clasp can therefore only be inserted into the through-hole from below or from above, but not pushed all the way through. The head lower face in the region of the through-hole or the lower end of the through-hole therefore advantageously forms a stop for the clasp towards the top if the lower end is wider than the diameter of the through-hole. When the system components are being assembled, the clasp can be prevented from moving upwards, if the lower end of the same is wider than the diameter of the through-hole, and out of the through-hole again. This makes assembling the elements much easier. Of course, the clasp may also be inserted from the head upper face into the through-hole towards the head lower face, in such a way that the head upper face in the region of the through-hole or the upper end of the through-hole, or alternatively a recess region of a recess as described below, forms a stop downwards for the clasp, if the upper end of the clasp corresponds to the lower end of the clasp described above.

In a preferred embodiment, the length of the clasp is longer than the through-hole. This is expedient, if the upper end of the clasp and/or the lower end of the clasp should protrude from the through-hole in the bait head. In this case, the through-hole extends from the head upper face to the head lower face. This is expedient because the lower end of the clasp then forms a receptacle which serves to hold one or more fishing hook devices and/or weight elements. The upper end of the clasp may preferably be used to attach a fishing line. Both ends of the clasp protrude outwards from the head, respectively forming receptacles to hold these additional elements.

As an alternative to this embodiment, the head of the fishing device may be made larger or smaller in size. This means that a higher or lower weight can be provided by way of the size of the head. Naturally, a larger head has a higher weight and a smaller head has a lower weight. In this embodiment, the through-hole is longer or shorter. However, a region on the head upper face around the through-hole and/or a region on the head lower face around the through-hole is formed as a recess in the head. This recess or these recesses delimit the length of the through-hole, which in this case no longer ends at the head upper face and/or head lower face. The respective ends of the clasp, which preferably remain the same size regardless of the head size, are located with their receptacles in this recess, in such a way that they are protected from external influences but are easily accessible for hanging fishing elements. The clasp is thus advantageously arranged completely or at least 90% or 95% inside the head excluding the recess. In this case, the lower end of the clasp, in particular the first receptacle formed at the lower end of the clasp, expediently protrudes from a first recess provided on the head lower face, but does not protrude beyond the head lower face. The receptacle formed by the lower end of the clasp is thus protected from external influences, but at the same time is easily accessible. The same applies to the upper end of the clasp, which is also arranged in a second recess on the head upper face, preferably within the second recess. The upper end of the clasp and the second receptacle formed by the upper end of the clasp are preferably received in the second recess in such a way that said end does not protrude beyond the head upper face. However, it is expedient for approximately between 0.1 and 20%, particularly 5%, particularly preferably between 2 and 5 mm of the upper part of the clasp to protrude from the head or the through-hole. The fishing line, hooks or hook systems can be attached more easily in this case.

The fishing device is primarily intended to make it possible for the weight(s) and/or fishing hooks or fishing hook systems and bait to be replaced quickly. With a heavy head with a larger volume, the dimensions of the through-hole, in other words the length and diameter, remain the same as for heads of other sizes, since a uniform clasp length is expedient. This has the advantage that different head variants can be mounted even with the same clasp length. It is important here that the upper end of the clasp or the receptacle, preferably the tapered eyelet, always offers between 2 and 5 mm, preferably between 3 and 4 mm, of space so that a hook or carabiner can be threaded through and the connection between the upper end of the clasp, in particular the tapered eyelet of the clasp and the hook, is not restricted in its mobility. For this reason, there is a depression in the head, which is also referred to above as a recess.

In a particularly preferred embodiment, the fishing device comprises a bait holder made of metal or plastics material. Alternatively or additionally, the clasp may be made of metal or plastics material. Metal is preferably used as the material, since it is more durable than plastics material. Stainless steel is preferably used, since corrosion due to use of the fishing device in water is then delayed or even avoided. A durable fishing device is thus provided.

The bait head is expediently made of metal, preferably Zamak. The fishing device thus has a heavy body which brings the bait under water and keeps it there. Alternatively, the head may be made of a Zamak core coated with a plastics material, preferably polyurethane (PU). For the same sink rate, in other words the same weight, this alternative head achieves a greater displacement of the water and different travel properties of the head with the bait. Instead of Zamak, zinc, copper, tungsten or similar metals may be used.

In a particular embodiment, the head is formed unweighted and represents, so to speak, a floating version of the head. In this case, it is made entirely of plastics material, in such a way that a floating body is provided by the head.

The bait holder is expediently configured straight in the middle portion and at the rear end. Preferably, the middle portion and rear end are formed in one piece with the front end that forms the though-opening. The bait holder can thus be inserted in one piece into the blind hole opening provided in the bait head. No prior steps are required to connect or manufacture the bait holder from several bait holder parts. This has the advantage that the fishing device can be made ready for use in a short time.

In a preferred embodiment, the first blind hole leads horizontally from the rear head into the bait head. The first blind hole is expediently located in the middle of the rear head. It preferably extends from the rear head to the middle of the head, into the head interior. It expediently leads to the through-hole in the bait head, so that the first blind hole extends up to and including the wall of the through-hole at the rear head, which points towards the head front part. The second blind hole also preferably leads horizontally from the through-hole further into the bait head, specifically towards the front of the bait head. In this case, the second blind hole represents an extension of the first blind hole, with both the first and the second blind hole extending in the longitudinal direction of the axis A and at the same height in the head. This makes it possible for the bait holder to be pushed smoothly into the two blind holes. In addition, a positive connection is created between the bait holder and the head via the two blind holes. It is possible to configure the head with a spring-loaded pin that engages in an opposite recess in the bait holder at the front end of the bait holder and secures it in addition to the clasp in the head.

In a further configuration of the present invention, the front end of the bait holder is inserted into the bait head up to a first stop in the first blind hole. The first stop is formed by the wall of the through-hole opposite the first blind hole. Alternatively, the front end of the bait holder leads to a stop in the second blind hole, which leads deeper into the head or towards the front head front face, orthogonal to the through-hole, as an extension of the first blind hole. This arrangement is preferred because the second blind hole provides a hold for the bait holder and prevents it from pivoting up and down in the bait head. The bait holder is thus stabilised at the front end and held firmly inside the head. It can only be pulled out backwards, but can no longer be pivoted up or down or sideways. As soon as the clasp is inserted into the through-hole, it is no longer possible to move the bait holder back. It is thus firmly anchored in the head.

In a particularly preferred embodiment of the invention, the bait holder is provided with a spiral which extends at least over the middle portion of the bait holder. The spiral may be made of wire or plastics material. The bait holder and spiral are expediently formed as one piece. In this one-piece configuration, the bait holder is therefore formed from the rod-shaped or straight middle portion and rear portion or rear end, the front end again being bent, preferably forming an elongate eyelet, which is continued onwards here, in such a way that the bait holder is formed in a spiral shape after the eyelet has been formed, the spiral or spiral region of the bait holder winding around the middle portion and the rear end of the bait holder, both of which form a central mandrel, so to speak. The end of the spiral may end in the middle portion or in the region of the rear end of the bait holder. The end of the spiral is expediently formed open, so that the bait holder has a total of two open ends made up of a central mandrel and a spiral. A rubber bait can be put on and threaded onto these two ends by twisting it onto the spiral and placing it on the central mandrel.

In an alternative embodiment of the invention, a spiral is provided which is wound spirally around the bait holder. The spiral is expediently provided in the region of the middle portion or in the region of the middle portion and rear end of the bait holder. The spiral is attached either to the front end of the bait holder or between the front end and the middle portion thereof. The spiral is open towards the rear in such a way that a bait body, preferably a rubber bait, can be screwed onto the spiral and the bait holder can be inserted at the same time. The spiral is connected to the bait holder via a welded connection, and the spiral is thus permanently attached to the bait holder. The spiral or its open rear-facing end ends in the region of the middle portion towards the rear end of the bait holder or at the rear end of the bait holder. Expediently this is not right at the rear end of the bait holder, so that a hole can be added to an as yet unperforated rubber bait by means of the rear end of the bait holder and by placement thereon.

In a further alternative embodiment of the invention to the spiral described in the two preceding paragraphs, it is possible not to form the central mandrel in a straight line towards its rear end, but rather to form the rear end extended and bent back in a U-shape, in such a way that the end is formed as a point and thus the entire rear end is formed as a fish hook. In addition, a holding wire in the form of a U-shaped wire bracket with undulation of at least one of its two legs may be provided in the middle portion of the central mandrel, and is arranged below the middle portion and firmly attached, preferably soldered, to the middle portion of the mandrel by its upper holding leg. The connecting portion, which is formed between the two legs to form the U-shape, is expediently located on the head side, and the two open ends of the two legs point towards the rear end of the central mandrel, the legs extending substantially parallel to the central mandrel. One or both of the legs may be undulating in whole or in part. This provides another option for attaching bait to the head system. The undulating wire leg(s) hold the rubber bait in addition to the hook formed from the rear end, which is located above the central mandrel (central spike).

Another possible embodiment of the present invention comprises a diving vane which is releasably connected to the bait head via a fastening means. The diving vane supports the fishing device during submersion and thus facilitates fishing.

The fastening means may be a screw. It is particularly preferably a knurled screw. This means that the diving vane can be fastened in an instant, in other words in just a few steps. The fastening means is rotatably mounted in a receiving hole, preferably a screw hole, on the upper face of the diving vane. The receiving hole is expediently provided in a connecting element on the diving vane. The arrangement of the fastening means in the receiving hole is pre-assembled at the factory in such a way that an angler does not have to acquire the fastening means separately. The fastening means is therefore itself expediently an integral part of the diving vane and is therefore permanently mounted in the receiving hole. It therefore cannot be lost, and this is a major advantage since there are no small parts present during fishing.

The upward end, preferably provided with a thread portion, of the fastening device can be screwed into a bore, provided on the lower face of the bait head and having a counter thread or a lock nut with a counter thread which is firmly connected in the bore. This means that the diving vane can be used as desired: either so that the fishing device travels deeper in the water with the diving vane mounted on the fishing device, or so that the fishing device floats more at the top, without the diving vane mounted. In addition, different sizes of diving vanes may be mounted so that the depth to which the fishing device sinks can be determined individually.

The diving vane comprises a blade and a connecting element. The receiving hole expediently extends vertically through the connecting element. The connecting element protrudes to the rear from the rear face in the upper region of the diving vane, in other words is orientated counter to the direction of travel of the fishing device. The connecting element is advantageously provided below a notch on the rear face in the upper region of the blade, in such a way that the full surface of the blade, in particular the front of the diving vane, produces its full effect as a result of the flow running counter to the direction of travel of the fishing device. The blade is preferably rectangular and has a notch on its upper face. The notch is in the middle of the upper edge of the vane.

In a further configuration of the embodiment, the bait head has a first positioning element on its lower face. The diving vane has a second positioning element on its upper face. The second positioning element is preferably formed on the connecting element. The positioning elements interact with the fastening means in such a way that the diving vane can be brought into a locking position by means of a plug-in movement in the bait head via the positioning elements and can be fastened to the bait head by means of a rotary movement of the fastening means.

In the locking position, the blade is orientated transverse to the direction of travel of the fishing device. The direction of travel is along the X-axis. According to FIG. 7, the Z-axis extends transverse to the direction of travel, in other words parallel to the lower edge of the blade and at a 90 ° angle to the X-axis, so that the width B of the diving vane lies in a plane spanned between a Y-axis, which extends parallel to the side edges of the blade, and the Z-axis.

In a further embodiment of the invention, the head has an additional slot, formed as a blind hole, on its upper face. Additional accessories can be received in the slot, for example hooks or spinner blades and the like. The accessories are attached like the clasp-via the bait holder, preferably in the region of the portion immediately in front of the eyelet and the front portion of the holder.

The present invention further relates to an arrangement for a fishing device. This is characterised in that a bait holder is releasably inserted into a first blind hole which extends from the rear head into the head to at least one through-hole, which extends vertically from the head upper face to the head lower face. This first arrangement between the bait head and the bait holder is secured by a clasp in that this is also releasably inserted into the through-hole from the head upper face or from the head lower face.

The fishing device embodiments set out above are applicable to the 1:1 arrangement.

Furthermore, the invention proposes a method which makes it possible to manufacture a fishing device in accordance with the embodiments described above. The method comprises providing a bait head, a bait holder and a clasp, inserting the bait holder into a first, and preferably also a second, blind hole which leads horizontally from the rear head into the bait head. In a further step, the clasp is inserted from the head upper face or head lower face into a through-hole which leads completely through the bait head from the head upper face to the head lower face. Since the clasp is a pretensioned clasp, whose overlapping legs are pressed outwards towards the side walls of the through-hole, the clasp is clamped in the through-hole in such a way that it holds the bait holder in its position locked in the second blind hole. Only three method steps in total are necessary to manufacture the fishing device. This makes it possible for the angler to produce a stable fishing device suitable for use with rubber baits within a very short time. In a final step, the angler simply has to push the soft plastics material bait onto the rear end of the bait holder and/or screw the rubber bait onto a spiral on the bait holder. This has the advantage that the prepared baits, which are expediently rubber bait, can be stored together with the bait holder. The fishing hooks or fishing hook systems may be stored separately or already be threaded into the clasp. The head may be formed anywhere from light to heavy and from sinking to floating and, depending on the fishing situation, may also be stored separately and then mounted or changed in accordance with the angler's specifications. In this way, with an assortment of each head variant, all rubber baits prepared with a bait holder can be used in a short time. Usually, the prior art baits are always firmly connected to a head or weight and to a hook and can therefore only be removed with a tool or without tools and by hand, whereby then, however, disassembly takes longer than with the present invention and wear and tear of the components of the prior art fishing device occurs. In addition, the risk of injury when the rubber bait is released from a head or weight and from a prior art hook is significantly increased if this is done by hand. However, an advantage of the invention is that the bait holder and the clasp are always appropriate for any head size.

Further advantageous configurations will be apparent from the description of the drawings and the dependent claims.

### BRIEF DESCRIPTION OF DRAWINGS

Two preferred embodiments of the invention are described in the following with reference to the purely schematic drawings, in which:

FIG. 1A is a longitudinal cross section through a bait head with an inserted bait holder and with a clasp threaded through the bait holder and head according to a first embodiment of the invention, FIG. 1B is a plan view of the bait holder, similar to what is shown in FIG. 1A, but with only one neck wrap and rotated through 90 ° about the axis A, FIG. 1C is a side view of the fishing device according to the first embodiment of the invention shown in FIG. 1A,

FIG. 2A is a longitudinal cross section along the axis A through a fishing device according to a second embodiment of the invention,

FIG. 2B is a side view of the fishing device according to FIG. 2A,

FIG. 2Cis a plan view of the fishing device according to FIG. 2A,

FIG. 2D is a front view of the fishing device according to the second embodiment,

FIG. 3A is a longitudinal cross section along the axis A through the fishing device according to the second embodiment of the invention, comprising further fishing elements, such as a retaining ring (snap ring, split ring or solid ring), 3-way rotary joint (3-way swivel joint), hook and the like,

FIG. 3B is a perspective view of the fishing device from diagonally in front according to the second embodiment,

FIG. 3C is a perspective view of the fishing device from diagonally behind according to the second embodiment,

FIG. 4A is a side view of the fishing device according to the first embodiment of the invention,

FIG. 4B is a side view of the fishing device according to the first embodiment of the invention,

FIG. 4C is a side view of the fishing device according to the first embodiment of the invention,

FIG. 5A is a side view of the fishing device according to a third embodiment of the invention,

FIG. 5B is a perspective view of the fishing device shown in FIG. 5A according to a third embodiment of the invention,

FIG. 6 is a cross section along the longitudinal axis of a head according to a further embodiment of the present invention,

FIG. 7 is a perspective view of a diving vane in the locking position,

FIG. 8 is a front view of the bait head with diving vane when dismantled,

FIG. 9 is a perspective view of the diving vane looking at the connecting element from above (without fastening means),

FIG. 10 is a plan view of the diving vane with connecting element (without fastening means),

FIG. 11 is a side view of the head 2 and the diving vane with fastening means,

FIG. 12 is a cross section along the longitudinal axis A or X-axis through the head and the diving vane when dismantled,

FIG. 13 is a front view of the diving vane, in particular the blade,

FIG. 14 is a side view of the diving vane,

FIG. 15 is a plan view of the head with mounted diving vane,

FIG. 16 shows the bait head with additional blind hole (receiving slot), and

FIG. 17 is a cross section in the longitudinal direction A through the head.

### DETAILED DESCRIPTION OF THE PREFERRED EMBODIMENTS

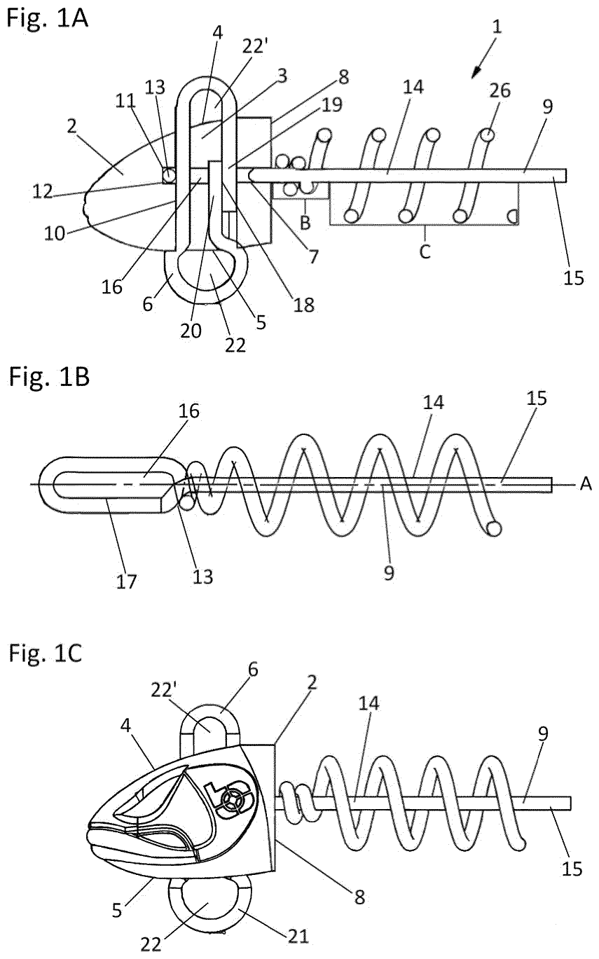

FIG. 1A shows a fishing device 1 according to a first embodiment of the present invention. The fishing device 1 consists of a head 2, which has a through-hole 3 which extends vertically from the head upper face 4 to the head lower face 5. The through-hole 3 serves to receive a clasp 6. The clasp 6 protrudes from the through-hole, as is clearly visible in FIG. 1A, at the head upper face 4 and at the head lower face 5, in such a way that the clasp 6 forms two receptacles 22, 22′ outside the head 2, which are used to attach fishing hooks, fishing line, fishing weights and similar fishing elements. The head 2 also has a first blind hole 7 which leads from the rear head 8 into the head 2 at least as far as the through-hole 3 to receive a bait holder 9. As a result of the clasp 6 formed like a staple, the fishing hook or fishing hook system can be mounted in the clasp without tools. This is preferably done before inserting the clasp 6 into the through-hole 3, in such a way that the fishing hook is housed in the lower receptacle 22 of the clasp.

In the first embodiment shown in FIG. 1A, the bait holder 9 is inserted as far as the stop into a second blind hole 12 inside the head 2, which continues in the wall 10, opposite an inner opening of the first blind hole, of the through-hole in the axial direction A (dashed line) of the bait holder from the first blind hole 7, which is formed open here. The front end 13 of the bait holder 9 is thus completely received in the head 2 and within the through-hole 3.

In an alternative configuration of the first embodiment and also of the second embodiment described below, the bait holder 9 may be configured in such a way that the stop does not occur in a second blind hole, but rather on the opposite wall 10 of the through-hole 3 if there is no second blind hole. However, the second blind hole 12 is expedient because the clasp 6 inserted into the through-hole 3 can then be received completely, and expediently in a positive fit, in a though-opening 16 of the bait holder. In addition, the bait holder 9 is held stably in the head 2 once it is inserted into the second blind hole 12.

The bait holder has a front end 13, a middle portion 14 and a rear end 15. The front end 13 of the wire 9 forms the through-opening 16 just described, in which the clasp 6 expediently engages in a positive fit. The bait holder is expediently bent at its front end 13 in such a way that an annular, preferably closed receptacle 16 is formed. The bent front end 13 may be polygonal, in other words square, or rounded, and is preferably formed as an eyelet 17. The clasp 6 has an overlap region 18 as a result of two overlapping legs 19 and 20. As a result of the inner pretensioned leg 20, a force from the leg 20 acts outwards on the outer leg 19, in such a way that the clasp is firmly clamped in the through-hole 3 as a result of pretension. The leg 20 acts like a pretensioned spring on the leg 19, specifically in the direction of the first blind hole 7. The arrangement here is merely exemplary, and the legs may also be pretensioned on the opposite side or in a different order. The bait holder 9 is thus held securely in the head 2 with the pretensioned clasp. A second securing in the through-hole is carried out by attaching a fishing line, hook, carabiner or retaining ring, as described above, specifically at the upper end 23 of the clasp, and at the same time attaching other fishing elements, such as fishing hooks, weights or connecting elements to the lower end 21 of the clasp 6.

FIG. 1A is also a cross section of a spiral portion 26 which extends over the middle region 14. The spiral portion 26 is wound in a spiral around the bait holder 9, the spiral portion 26 being attached to the middle portion 14 in the region adjacent to the front end 13 in the manner of a tight-fitting neck wrap, in this case double (but not necessarily double), around a head-side bait holding portion region B of the bait holder, and is spaced apart rearwards, towards the rear end 15 of the bait holder, from the central bait holding portion C and is open at the end, in other words is not attached to the rear end 15. The portion of the wire 9 which exits directly at the rear head may be referred to as the “region adjacent to the front end”. This means that a bait, for example a soft plastics material fishing bait body, can simply be screwed onto the spiral wrap from behind and placed on and attached to the central holding portion of the bait holder.

FIG. 1B is a plan view of a bait holder as shown in FIG. 1A, but in a view rotated through 90 ° about the axis A of FIG. 1A. The through-opening or clasp receptacle 16, which is expediently provided as an elongate eyelet, is thus clearly visible. The bait holder is expediently formed in one piece in this embodiment, although a multi-piece configuration is also possible. The longitudinal axis is indicated by the reference symbol A and by a dot-dash line. At its front end 13, the bait holder 9 is bent into an elongate eyelet which, after being bent or shaped, starting from the central mandrel, wraps tightly around the elongate or rod-shaped portion of the bait holder adjacent to the eyelet, and then, after completely wrapping the eyelet-side region B (neck wrap), extends in a somewhat wider spiral around the longitudinal axis of the bait holder in the direction of the rear end 15. The elongate eyelet is thus formed closed by a neck wrap of the spiral portion of the bait holder, the neck wrap of the spiral portion being adjacent to the central mandrel formed by the longitudinal axis and at least one, as shown here, but preferably two complete wraps around the longitudinal axis. The spiral portion of the bait holder is then wound at a distance from the central mandrel. The spiral end is expediently formed open and also at a distance from the central mandrel. In this embodiment, the outermost points of two spiral windings on one side of the axis are 6 mm apart. The winding angle with respect to the longitudinal axis A is 78.4 °. In all embodiments, a characteristic feature of the spiral according to the invention is that it does not lie in a plane, but rather forms a three-dimensional structure along the longitudinal axis A. The rubber bait can therefore be screwed onto the spiral. The diameter of the spiral, which can be determined in the middle portion of the bait holder, is 8 mm in this embodiment. The diameter of the bait holder is 1.2 mm. It should be noted that the measurement specifications are merely exemplary and that other measurements and dimensions are possible.

FIG. 1C is a side view of the fishing device 1 according to FIG. 1A. The bait head is expediently configured streamlined, but may also have other shapes. The head contours shown in the drawings, in particular the mouth, eye and gills, are merely exemplary, and the head according to the invention may also be configured without these structures or contours. The head-side bait holder portion region or eyelet-side region here has a double neck winding, unlike the bait holder shown in FIG. 1B.

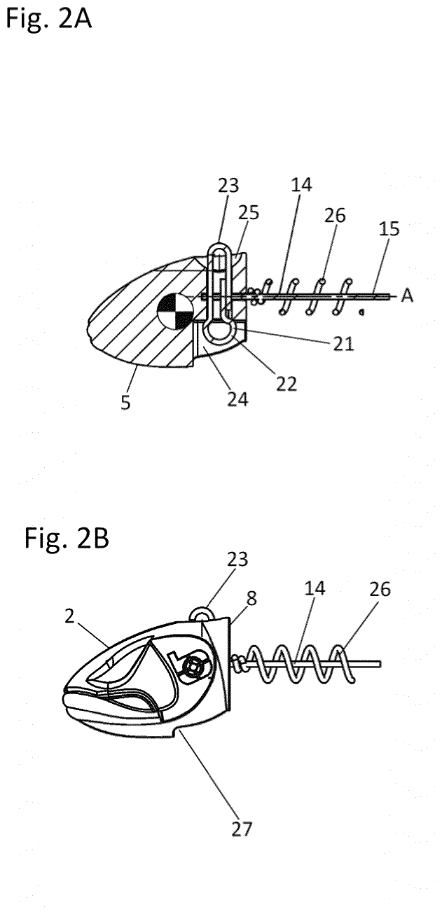

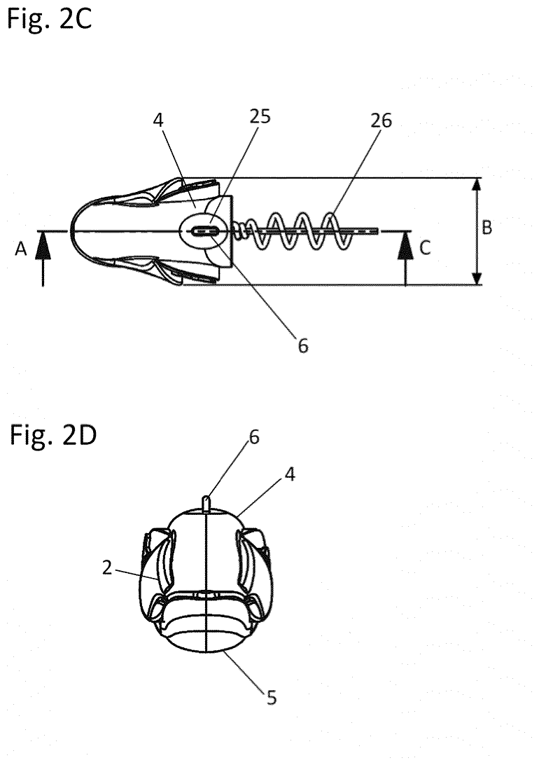

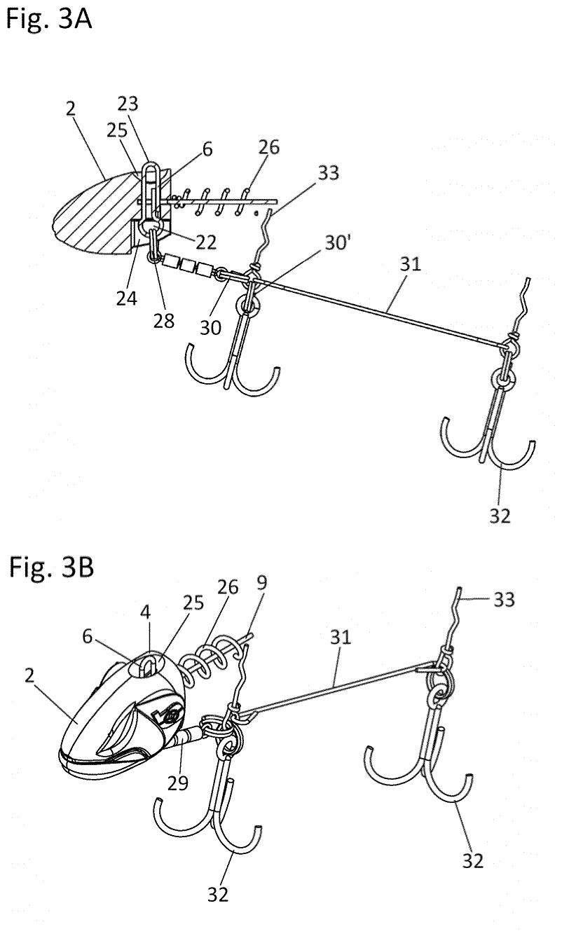

FIG. 2A to 2D and 3A to 3C show a second embodiment of a fishing device according to the present invention. The second embodiment differs from the first embodiment in that a first recess 24, in which the lower end 21 of the clasp 6 is received, is provided on the head lower face 5. The lower end 21 is protected by the receptacle in the recess 24, since the rest of the head, at the front and side in the pulling or floating direction of the bait, grips the lower end 21 of the clasp 6, as can be clearly seen in FIG. 2A in conjunction with FIG. 2B. The clasp 6 is accessible from the rear head 8, just as it is from the head lower face 5, in such a way that the lower end 21 of the clasp 6 can easily be grasped with two fingers and pulled out of the through-hole 3 (in a downward direction). Likewise, a type of trough 25 or a second recess 25, in the centre of which the through-hole 3 leads into the head interior, is expediently present on the head upper face 4.

FIG. 2A is a cross-section through the fishing device 1 according to the second embodiment. It is clearly visible that the lower end 21 of the clasp is completely received in the head, in other words does not protrude downwards.

FIG. 2B is a side view of the fishing device according to FIG. 2A. Here, the lower end 21 of the clasp is completely received in the head 2 and in particular is hidden, in other words no longer visible from the outside in the side view, although a lateral partial recess 27 is provided on the head and extends from the head lower face 5 to the rear head 8 so as to allow easier access by hand. The first recess 24, in which the lower end of the clasp is received, is deeper than the partial recess.

FIG. 2C is a plan view of the fishing device 1 according to the second embodiment. In this plan view, the trough-shaped second recess 25 on the head upper face 4 is clearly visible. The clasp 6, of which the upper region can clearly be seen, is received therein. The spiral portion 26 is again wound spirally around the middle portion 14 of the bait holder 9. The winding width is expediently smaller than the width of the rubber bait. The width of the head is 23.8 mm in this embodiment. In the second embodiment shown, the length of the fishing device 1 from the head front face to the rear end of the bait holder is 9.68 mm. The head is 28 mm high, as measured from the head lower face 5 to the head upper face 4, including the clasp portion which protrudes upwards, which is visible in particular in FIG. 2D. The trough-shaped recess 25 on the head upper face 4 has a depth of 3.5 mm. The measurement specifications are merely exemplary, and other measurements and dimensions are possible.

FIG. 2D is a front view of the fishing device 1, in particular the bait head 2. On the head upper face 4, it is possible to see the trough-shaped second recess 25 and the part of the clasp 6 which protrudes upwards from this recess 25 and over the head upper face 4. A fishing line (not shown here) can be attached here.

FIG. 3A to 3C show the attachment of further fishing elements, such as fishing hooks 32, to the clasp 6.

The cross section shown in FIG. 3A clarifies the connection between the receptacle 22 at the lower end 21 of the clasp 6 and the other fishing elements. A retaining ring 28 is arranged at the lower end 21 of the clasp 6, as well as swivel joints 29 thereon. In this embodiment, three swivel joints 29 are shown merely by way of example. Thus, fewer or more swivel joints may be provided. The swivel joints are followed by a further retaining ring 30 (such as a snap ring or split ring), on which a wire 31, preferably made of steel or titanium, or alternatively a strand, is connected with respect to the retaining ring 30 via a stinger spike 33. Another retaining ring 30′ is located at the lower eyelet-shaped end of this stinger spike 33, to which a hook 32, here a treble hook, is attached. Other arrangements of hooks 32, swivel joints 29, spikes 32 and retaining rings 28, 30, 30′ are possible.

FIGS. 3B and 3C are perspective views of the fishing device shown in FIG. 3A with the corresponding further fishing elements, FIG. 3B being a perspective view from diagonally in front and FIG. 3C being a perspective view from diagonally behind.

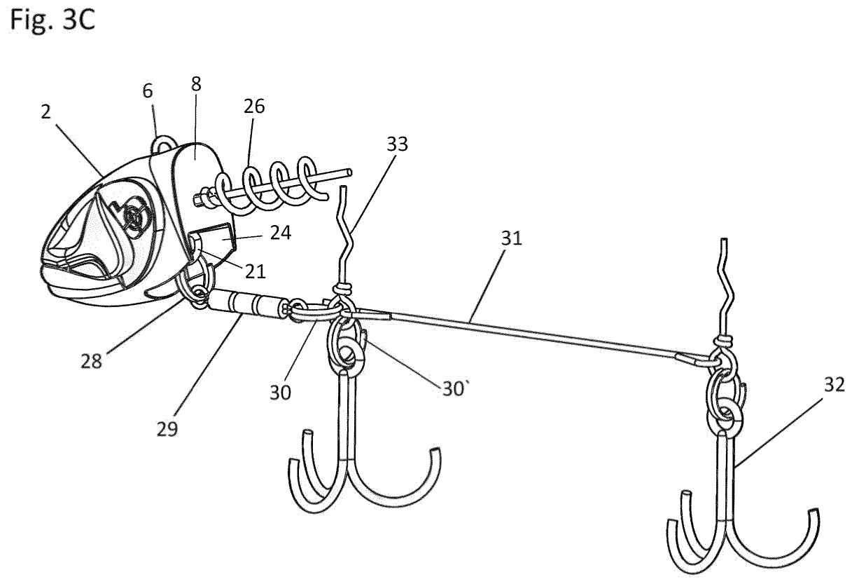

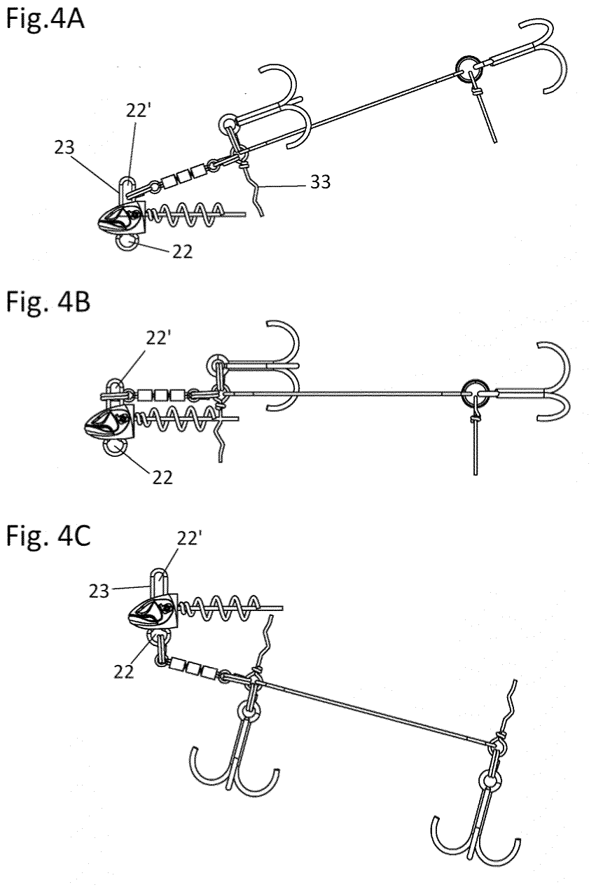

FIG. 4A to 4C show three further devices according to FIG. 1A. In FIG. 4A, a retaining ring is received in the upper receptacle 22′, which is formed by the upper end of the clasp 23. Attached to this is a three-way joint with another retaining ring, followed by a stinger spike 33, to which another retaining ring is also attached, which in turn has a hook (here: a treble hook). Further fishing hooks and fishing connection elements are connected (but not described further here, since the possible combinations are wide-ranging and are not intended to limit the invention).

FIG. 4B shows a retaining ring slipped over the upper end of the clasp 23, which is attached to the end of the clasp 23 with another retaining ring. Further fishing hooks and fishing connection elements are connected (but not described further here, since the possible combinations are wide-ranging and are not intended to limit the invention). FIG. 4C corresponds to the first embodiment, as shown in FIG. 1C (side view), a retaining ring being attached in the lower receptacle 22 and a three-way joint with further fishing hooks and connection elements being attached thereto.

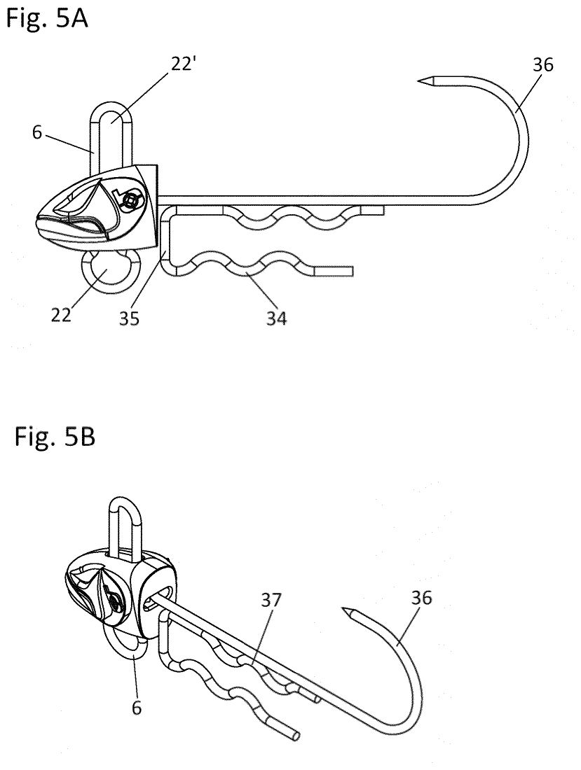

FIG. 5A is a side view of a third fishing device according to the invention. The central mandrel of the bait holder is extended at its rear end 15, the extended end being bent upwards in a U-shape and back towards the head side. The end is formed as a point, in such a way that as a whole the extended rear end forms a hook 36. In addition to this bait holder, there is a holding wire in the middle portion of the central mandrel, or more precisely on the lower face of the middle portion 14, which is formed as a U-shaped wire bracket. The legs 34, 37 of the U-shaped wire bracket extend parallel to the central mandrel and may each be undulating in whole or in part. The connecting portion 35 between the two legs 34, 37 is provided on the head side and spaces the two legs 34, 37 apart from one another. The upper leg is attached to the lower face of the middle portion 14 of the bait holder via a soldered connection. The legs 34, 37 of the wire bracket are inserted into the rubber bait in addition to the hook 36 formed from the rear end. The rubber bait is thus securely attached to the bait holder system and doubly secured.

FIG. 5B is a perspective view of this third embodiment.

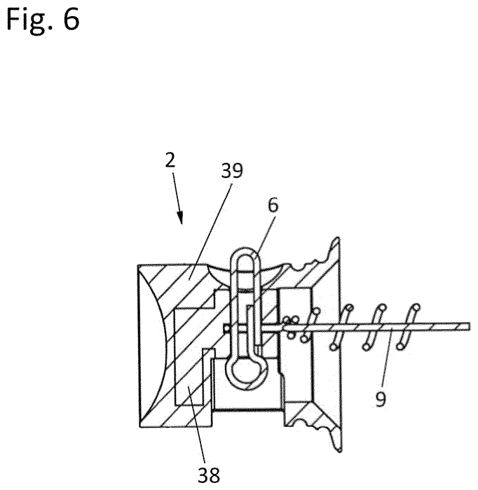

FIG. 6 is a cross section of a bait head 2 according to a further embodiment of the invention, the cross section through the head 2 being taken in the longitudinal direction of the axis A. The clasp 6 is mounted in the bait head 2 together with the bait holder 9. The middle portion of the clasp 6 leads through a core made of the material Zamak, which forms the interior of the bait head 2. This material region in the head is denoted by reference numeral 38. Both the bait holder 9 and the clasp 6 are received in this material region. The core 38 made of Zamak, which may also alternatively be made of another material having a higher density than water (1 kg/dm³), in particular with the property of sinking, for example made of lead, tungsten or steel, is overmoulded with a plastics material 39. With this configuration, the weight of a head can be influenced, as can its buoyancy properties (sink rate) in the water. This configuration has the advantage that the parts movably arranged in the bait head, in other words the clasp 6 and bait holder 9, do not damage the head interior at the points at which these system parts slide along, as a result of the material in the interior which is harder than the plastics material, in this embodiment Zamak or one of the above-mentioned alternatives, and the head interior, in particular the through-hole 3 and the first blind hole 7, or also alternatively the second blind hole 12, are not damaged or worn out too quickly with frequent use of the fishing device.

Thus, the major advantage in practice is that the size, shape and weight of the head are not necessarily related to the sink rate of the head. A heavier head with a lower sink rate can therefore achieve a greater casting distance than a head made of solid material such as Zamak, lead or tungsten. At the same time, when retrieved, the bait floats at the desired depth, in accordance with the sink rate of the head, just as with a pierced, lighter head of a higher density.

This head displaces significantly more water than a head of a higher density and smaller volume at the same sink rate. The geometry of the head, the larger surface region and the concave depression on the surface in the pulling direction force the head to move more in the water. The head and bait get more left-right movement when they are pulled through the water. In addition, the collar at the end of the head may be equipped with a ring of fringes made of plastics material, deer hair, feathers or leather or metallic spinner blades, which play seductively in the water and generate micro-vibrations.

This makes the head with bait even more attractive to predatory fish and is intended to entice them to bite.

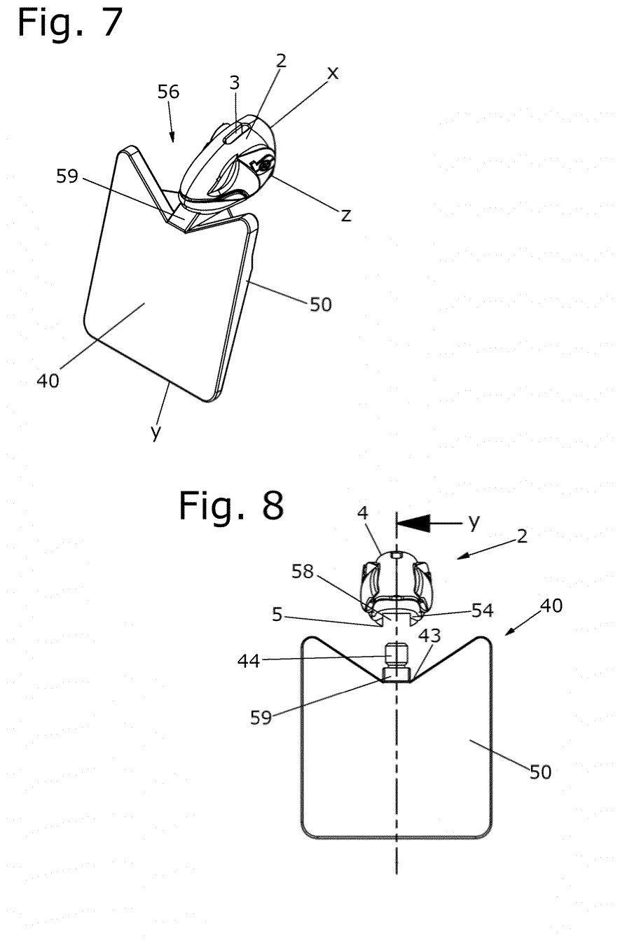

In a development of the invention, the bait head 2 comprises a diving vane 40. This bait head system made up of the diving vane 40 and bait head 2 is shown in FIG. 7 to 15.

FIG. 7 shows the diving vane 40 in the locked position (locking position 56). The diving vane 40 is mounted transverse to the direction of travel of the fishing device 1. For clarity, the coordinate system with the X-axis, Y-axis (pointing downwards) and Z-axis is shown. The blade 50 of the diving vane 40 lies in the plane spanned between the Z-axis and Y-axis, the blade 50 lying half in the plane spanned on the left (not shown) and half in the plane spanned on the right (Z and Y axes shown). The through-hole 3 through which the clasp 6 is inserted is also shown.

As is shown in FIG. 8, the diving vane 40 is inserted into the bait head 2 from below and is introduced into a bore 46 in the bait head 2. The locking is carried out via a tongue-and-groove connection or positioning elements 54, 55. The fastening is carried out via a fastening means 41, preferably a screw connection, as is described in the following. Also visible in FIG. 8 is the width B of the diving vane, or more precisely of the blade of the diving vane.

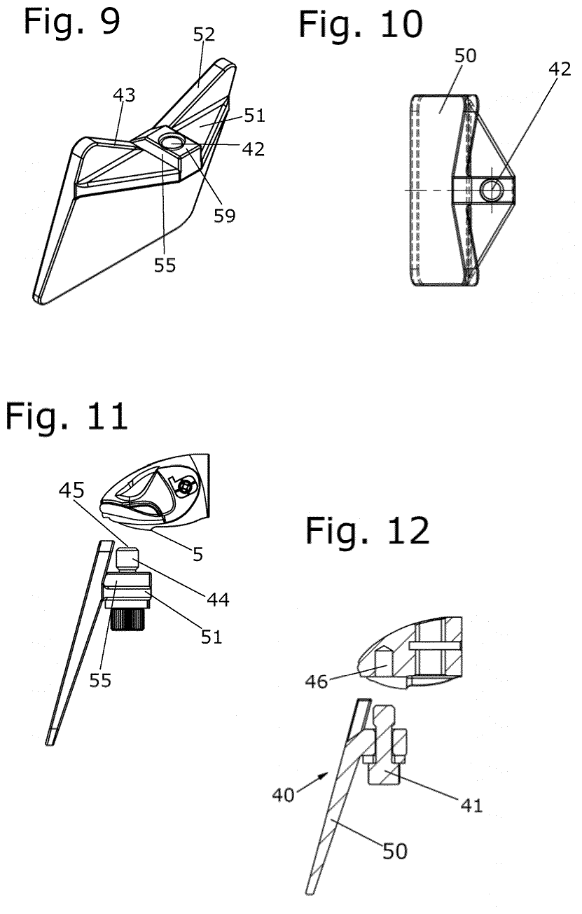

The bait head 2 and the diving vane 40 are releasably interconnected via the fastening means 41, as is shown in FIG. 7. The fastening means 41 is preferably a screw, particularly preferably a knurled screw. The fastening means 41 is rotatably mounted in a receiving hole 42 (shown in FIG. 9), preferably a screw hole, which is provided on the upper face 43 of the diving vane 40. FIGS. 9 and 10 show the receiving hole 42, and FIG. 12 is a cross-sectional view through the head 2 and diving vane 40 along the longitudinal axis X.

In FIG. 11, the fastening means 41 is shown in its position received in the receiving hole 42. A thread portion 44 (not visually shown) is provided at the upper end of the screw 41. The knurled head with its grooves for easy screwing by hand is located at the lower end of the screw.

The upward end 45, provided with a thread portion 44, of the fastening means 41 can be screwed into a bore 46 provided on the lower face 5 of the bait head 2. This is shown in FIG. 12. The bore 46 comprises a thread 48 (not shown) or a threaded lock nut 49 (not shown here) which is firmly connected in the bore and can be mounted in the bore 46 (see FIG. 17).

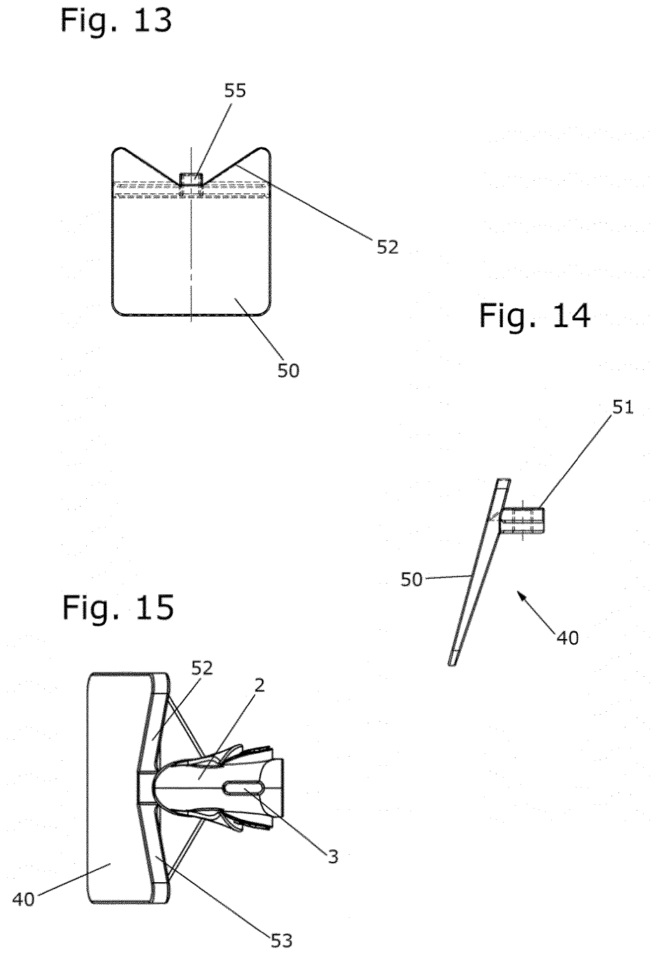

The diving vane 40 comprises a blade 50 and a connecting element 51, as is shown in FIG. 14. The blade 50 is substantially rectangular in shape and is formed with a central notch 52 on its upper face 53, as can be clearly seen in FIGS. 8 and 13. The second positioning element 55 is located in the middle of the notch 52.

The bait head 2 has a first positioning element 54 on its lower face 5, as is shown in FIG. 8. This is a groove which leads from the head lower face 5 into the head 2. The diving vane 40, in turn, has a second positioning element 55, shown in FIGS. 9 and 11, on its upper face 43. The second positioning element 55 is formed in the manner of a collar 59 (see FIG. 8), preferably on the connecting element 51. The connecting element 51 is shown in FIG. 9. The positioning elements 54, 55 interact with the fastening means 41 in such a way that the diving vane 40 can be positioned in a locking position 56 in the bait head 2 by means of a plug-in movement and can be fastened to the bait head 2 by means of a rotary movement of the fastening means 41. The positioning element 55 engages in a positive fit in the groove formed by the first positioning element 54. The elements fit together precisely.

In the locking position 56, the blade 50 is arranged transverse to the direction of travel 57 of the fishing device 2. The direction of travel extends along the X-axis. According to FIG. 7, the Z-axis extends orthogonal to the direction of travel. The diving vane is arranged in the plane spanned between the Z-axis and Y-axis. The blade 50 extends downwards along the Y-axis, as is shown in FIG. 7.

FIG. 14 is a side view of the diving vane 50, with the connecting element 51.

FIG. 15 is a plan view of the bait head 2 and the diving vane 40 attached thereto.

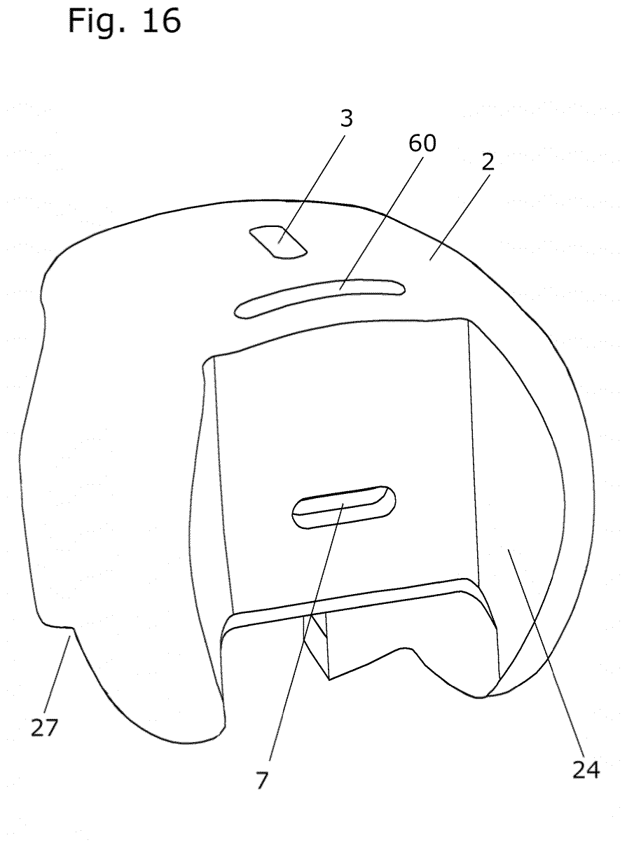

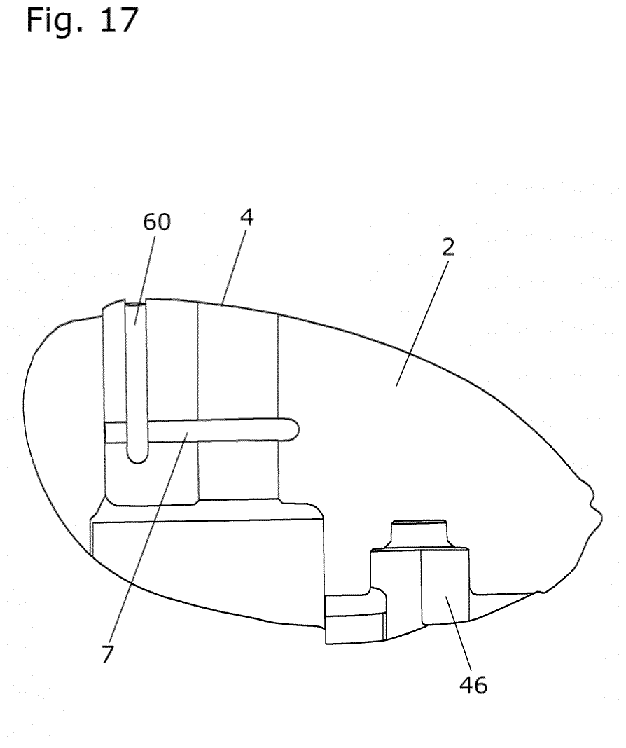

FIG. 16 is a rear view of the head 2. FIG. 17 is a cross section along the longitudinal axis X of the head 2. In both drawings, a receiving slot 60 can be seen, which is provided on the head upper face 4 and leads into the head interior. The receiving slot 60 is formed as an additional blind hole to the blind holes 7 and 12, and, unlike the blind hole 7 and blind hole 12, does not protrude from the rear head into the head or from the through-hole 3 into the front region of the head 2, but rather from the upper head face 4 vertically into the head interior. The receiving slot 60 serves to receive additional accessories, such as spinner blades, weed guards, hooks and the like. A nut can subsequently be fixed in the bore 46 shown in FIG. 17, so as to attach the replaceable diving vane 40.

### LIST OF REFERENCE SYMBOLS

1 Fishing device
2 Bait head
3 Through-hole
4 Head upper face
5 Head lower face
6 Clasp
7 First blind hole
8 Rear head
9 Bait holder
10 Opposite wall
11 End of second blind hole
12 Second blind hole
13 Front end of bait holder
14 Middle portion of bait holder
15 Rear end of bait holder
16 Through-opening
17 Eyelet
18 Overlap region of the legs
19 Overlapping leg
20 Inner leg
21 Lower end of clasp
22 Receptacle of clasp
23 Upper end of clasp
24 First recess
25 Second recess
26 Spiral portion
27 Partial recess in head
28 Retaining ring
29 Swivel joint
30, 30′ Retaining ring
31 Wire
32 Hook
33 Stinger spike
34 Leg
35 Connecting portion
36 Hook
37 Leg
38 Zamak core
39 Plastics material overmoulding
40 Diving vane
41 Fastening means
42 Receiving hole
43 Upper face of diving vane
44 Thread portion
45 Upwards-facing end of fastening means
46 Bore
50 Blade
51 Connecting element
52 Notch
53 Blade upper face
54 First positioning element
55 Second positioning element
56 Locking position
57 Direction of travel
58 Third recess
59 Collar
60 Receiving slot
A Longitudinal axis of straight bait holder portion
B Width of diving vane
X X-axis (direction of travel of fishing device)
Y Y-axis
Z Z-axis (plane of blade 50)

1.-20. (canceled)

21. A fishing device for a rubber bait for catching fish, comprising:
a bait head that includes a through-hole which extends vertically from a head upper face to a head lower face for receiving a clasp and a first blind hole which leads from a rear head into the bait head at least as far as the through-hole for receiving a bait holder such that a wall of the through-hole opposite the blind hole or an end of a second blind hole formed therein forms a stop for a front end of the bait holder;
wherein the bait holder is configured to fasten to the bait head and having at least a front end, a middle portion and a rear end, the front end of the bait holder being bent to form a through-opening including an eyelet which extends in a longitudinal direction of the bait holder axis configured to be releasably inserted into the blind hole; and
wherein the clasp is configured to be inserted into the through-hole and through the through-opening of the bait holder and can thus be releasably connected to the bait head and bait holder to secure the bait holder in the bait head.

22. The fishing device according to claim 21, wherein the eyelet is elongated in an axial direction.

23. The fishing device according to claim 21, wherein the clasp is formed like a staple with only one overlap region of two overlapping legs of the clasp.

24. The fishing device according to claim 21, wherein the clasp has an upper end and a lower end, wherein the lower end and/or the upper end of the clasp forms an annular, angular or eyelet-shaped receptacle for fastening further elements, the receptacle formed by the lower end of the clasp or the receptacle formed by the upper end of the clasp being wider than the width of the through-hole.

25. The fishing device according to claim 21, wherein a length of the clasp is longer than the through-hole such that the upper end of the clasp and/or the lower end of the clasp protrudes from the through-hole and wherein a lower receptacle of the lower end is configured to fasten one or more fishing hook devices and/or weight elements and/or the the upper receptacle of the clasp is configured to fasten a fishing line.

26. The fishing device according to claim 21, wherein the bait holder comprises metal or plastics material and/or the clasp comprises metal or a plastic material.

27. The fishing device according to claim 21, wherein the bait head comprises Zamak, zinc, copper or tungsten and/or a plastic material.

28. The fishing device according to claim 21, wherein the bait head comprises a plastic material or has a core made of Zamak which is overmoulded with a plastic material.

29. The fishing device according to claim 21, wherein the bait holder is formed straight in the axial direction in the middle portion and at the rear end, and in one piece with the front end forming the through-opening.

30. The fishing device according to claim 21, wherein the first blind hole and the second blind hole lead horizontally from the rear head to a middle of the head.

31. The fishing device according to claim 21, wherein the front end of the bait holder is inserted into the bait head as far as the stop in the first blind hole, formed by the opposite wall of the through-hole, or as far as the stop in the second blind hole.

32. The fishing device according to claim 21, wherein the middle portion and rear end form a central mandrel, and, in the region of the middle portion or in the region of the middle portion and rear end of the bait holder, a spiral portion is provided, which is formed from the bait holder and wound around its central mandrel and is arranged between the front end and middle portion in the manner of a neck winding, closely fitting around a head-side portion region of the bait holder, which adjoins the elongate eyelet, in at least one complete winding of the same, wherein the spiral winding of the spiral portion in the region of the middle portion to the adjacent region of the rear end or between the middle portion and the rear end or at the rear end of the bait holder is open as a spiral end and is arranged at a distance from the central mandrel.

33. The fishing device according to claim 21, wherein the rear end of the bait holder is extended and U-shaped upwards and then bent back towards the head side, the end being tapered to a point and a holding wire being provided on the lower face of the middle portion of the bait holder, which is U-shaped as a wire bracket and has two legs which are arranged with a head-side connecting portion extending parallel to one another and parallel to the middle portion of the bait holder, at least one of the legs being undulating in whole or in part and the upper leg being fastened, preferably soldered, to the lower face of the middle portion of the bait holder.

34. The fishing device according to claim 21, wherein the through-hole leads diagonally through the head, at an angle to the longitudinal axis of the bait holder between greater than 0 °and less than 180 °.

35. The fishing device according to claim 34, wherein the angle is between 1 ° and 179 °.

36. The fishing device according to claim 35, wherein the angle is between 50 ° and 130 °.

37. The fishing device according to claim 21, wherein the bait head comprises a diving vane;
the bait head and diving vane being releasably interconnected via a fastener which is preferably a knurled screw;
the fastener being rotatably mounted in a screw hole, on the upper face of the diving vane, and an upward end provided with a thread portion being screwable into a bore, provided on the lower face of the bait head and having a thread or a threaded lock nut firmly connected in the bore.

38. The fishing device according to claim 37, wherein the diving vane comprises a blade and a connecting element, the blade being rectangular and being formed with a central notch on an upper face.

39. The fishing device according to claim 38, wherein the bait head has on a lower face a first positioning element and the diving vane has on an upper face a second positioning element, which is formed on the connecting element, the positioning elements interacting with the fastener such that the diving vane can be positioned in a locking position in the bait head by a plug-in movement and can be fastened to the bait head by a rotary movement of the fastening means.

40. The fishing device according to claim 38, wherein the blade is arranged in the locking position transverse to the direction of travel of the fishing device.

41. The fishing device according to claim 39, wherein the bait head has a third recess on the lower face as the first positioning element and the bore leading into the head interior via this recess as the first fixing element,
the diving vane has as a second positioning element a collar which projects upwards on its upper face and which is formed to fit precisely and in a positive fit with the recess and is provided with the receiving hole as a second fixing element, and
the diving vane being connected to the bait head via the fastener, which is rotatably mounted in the screw hole.

42. The fishing device according to claim 21, wherein a receiving slot formed as a blind hole is formed in the head for fastening fishing accessories, and projects vertically from the head upper face into the head interior and crosses the first blind hole.

43. An arrangement for a fishing device, comprising:
a bait head having a through-hole which extends vertically from a head upper face to a head lower face and having a first blind hole which leads from a rear head into the bait head at least as far as the through-hole, a bait holder is releasably inserted into the blind hole, and a clasp is releasably inserted into the through-hole from the head upper face or from the head lower face.

44. A method for producing a fishing device, comprising:
providing a bait head, a bait holder and a clasp;
inserting the bait holder into a first blind hole, which extends from the rear head into the bait head; and
inserting the clasp from the head upper face or head lower face into a through-hole in the bait head.
